(19) United States
(12) Patent Application Publication
(10) Pub. No.: US 2012/0110793 A1
(43) Pub. Date: May 10, 2012

(54) FASTENER

(75) Inventors: Yasuhiro Watanabe, Aichi (JP); Akihiro Tamaoki, Gifu (JP)

(73) Assignee: NIFCO INC., Yokohama-shi, Kanagawa, (JP)

(21) Appl. No.: 13/322,371

(22) PCT Filed: May 12, 2010
(86) PCT No.: PCT/JP2010/058054

§ 371 Date: Jan. 20, 2012

(30) Foreign Application Priority Data
May 28, 2009 (JP) 2009-129161

(51) Int. Cl. F16B 19/00

(52) U.S. Cl. 24/289

(57) ABSTRACT

A fastener with which an operator can get a click feeling (tactile feedback) when a mounting member is mounted to a mounted member is obtained.

If a door trim (60) is pressed toward a door inner panel (62), locking claws are locked to a hole edge portion (64A) of a mounting hole (64) and, as a result, a leg portion (16) is fixed to the door inner panel (62). Moreover, an outer peripheral edge (46) of a flange member (14) contacts the door inner panel (62) and the flange member (14) is pressed by a first disc portion (20) toward the door inner panel (62). Then, plate chips (52) formed on the flange member (14) contact protruding portions (40) formed on the leg portion (16) and are elastically deformed and bent. When the plate chips (52) surmount the protruding portions (40), the plate chips (52) elastically recover. In this manner, when the door trim (60) is mounted to the door inner panel (62), the plate chips (52) surmount the protruding portions (40) to elastically recover, which gives the click feeling (tactile feedback) to the operator.

### TECHNICAL FIELD

The present invention relates to a fastener for mounting a mounting member to a mounted member.

### BACKGROUND ART

A fastener described in Patent Document 1 (Japanese Examined Utility Model Publication No. 60-17527) is provided with a leg portion to be inserted into a mounting hole in a mounted member. On a peripheral face of the leg portion, many fin-shaped locking claws to be locked to a hole edge portion of the mounting hole are provided.

With this structure, if the leg portion of the fastener is inserted into the mounting hole, any of the locking claws are locked to the hole edge portion of the mounting hole. In this way, leg portion is prevented from slipping out and a locked state of the leg portion and the mounting hole is achieved.

### DISCLOSURE OF THE INVENTION

### Problems to be Solved by the Invention

However, with the prior-art fastener, some of the locking claws are locked to the hole edge portion of the mounting hole, even if the leg portion is not sufficiently inserted. Therefore, even if the insertion is insufficient, a worker may incorrectly recognize that the leg portion of the fastener has been sufficiently inserted into the mounting hole in some cases.

In other words, because a click feeling (tactile feedback) is not given even when the leg portion is sufficiently inserted into the mounting hole, the operator incorrectly recognizes that the leg portion, which is prevented by the locking claws from slipping out, has been sufficiently inserted into the mounting hole. Then, the operator may think that the mounting member was mounted to the mounted member.

With the above facts in view, it is an object of the present invention to enable an operator to get a click feeling (tactile feedback) when mounting a mounting member to a mounted member.

### Means or Solving the Problems

A fastener according to a first aspect of the present invention includes: a main body member including a leg portion adapted to be inserted into amounting hole formed in a mounted member, a plurality of locking claws provided on a peripheral face of the leg portion and adapted to be locked to a hole edge portion of the mounting hole, a fixing portion provided on an end portion of the leg portion and to which a mounting member mounted to the mounted member is adapted to be fixed, and a tactile feedback portion provided on the peripheral face of the leg portion; a flange member in which the leg portion provided on the main body member is inserted and pressed against the mounted member when the leg portion is inserted into the mounting hole formed in the mounted member and the mounting member is mounted to the mounted member; and a surmount portion formed on the flange member for surmounting the tactile feedback portion when the flange member is pressed against the mounted member.

With this structure, the mounting member to be mounted to the mounted member is fixed to the fixing portion of the main body member. If the leg portion of the main body member is inserted into the mounting hole in the mounted member, the plurality of locking claws provided on the peripheral face of the leg portion are locked to the hole edge portion of the mounting hole and the leg portion is prevented from slipping out of the mounting hole.

Furthermore, if the leg portion is pushed into the mounting hole and the mounting member is mounted to the mounted member, the flange member is pressed against the mounted member. If the flange member is pressed against the mounted member, the surmount portion formed on the flange member surmounts the tactile feedback portion.

In this manner, when the mounting member is mounted to the mounted member, the surmount portion surmounts the tactile feedback portion to thereby give a click feeling (tactile feedback) to an operator.

In above-described aspect, the tactile feedback portion is provided in such a position as not to contact the mounted member when the leg portion is inserted into the mounting hole in the mounted member.

With this structure, the tactile feedback portion is provided in such a position as not to contact the mounted member when the leg portion is inserted into the mounting hole in the mounted member. Therefore, even if a shape of the tactile feedback portion is changed to tune the click feeling, it does not change a force of the leg portion to be inserted into the mounting hole.

In the above-described aspect, the tactile feedback portion is a protruding portion protruding from the peripheral face of the leg portion and the surmount portion is a plate chip which extends from a hole edge of an insertion hole toward a center of the flange member and which surmounts the protruding portion.

With this structure, if the mounting member is mounted to the mounted member, the plate chip of the flange member surmounts the protruding portion protruding from the peripheral face of the leg portion. As a result, the operator gets the click feeling.

In this manner, it is possible to give the click feeling with the simple structure.

In the above-described aspect, a guide portion for guiding the flange portion fitted over the leg portion is formed to extend in a longitudinal direction of the leg portion and protrude from the peripheral face of the leg portion and the pair of plate chips is provided to the flange member and a recessed portion guided by the guide portion is formed between the pair of plate chips.

With this structure, the recessed portion formed on the flange member is guided by the guide portion formed to protrude from the peripheral face of the leg portion. As a result, the flange member is disposed in a predetermined position with respect to the leg portion.

If the recessed portion is guided by the guide portion in this manner, it is easy to dispose the flange member in the predetermined position.

### EFFECTS OF THE INVENTION

With the present invention, the operator can obtain the click feeling (tactile feedback) when the mounting member is mounted to the mounted member.

### BRIEF DESCRIPTION OF THE DRAWINGS

FIG. 1 is a cross-sectional view of a fastener according to a first embodiment of the present invention.

FIG. 2 is a side view of the fastener according to the first embodiment of the present invention.

FIG. 3 is a cross-sectional view of the fastener according to the first embodiment of the present invention.

FIG. 4 is a cross-sectional view of the fastener according to the first embodiment of the present invention.

FIG. 5 is a side view of the fastener according to the first embodiment of the present invention.

FIG. 6 is a cross-sectional view of the fastener according to the first embodiment of the present invention and taken in a direction orthogonal to a longitudinal direction of a leg portion.

FIG. 7 is an exploded perspective view of the fastener according to the first embodiment of the present invention.

FIG. 8 is a perspective view of the fastener according to the first embodiment of the present invention.

FIG. 9 is a perspective view of the fastener according to the first embodiment of the present invention.

FIG. 10 is a cross-sectional view of a fastener according to a second embodiment of the present invention.

FIG. 11 is a cross-sectional view of the fastener according to the second embodiment of the present invention.

### BEST MODE FOR CARRYING OUT THE INVENTION

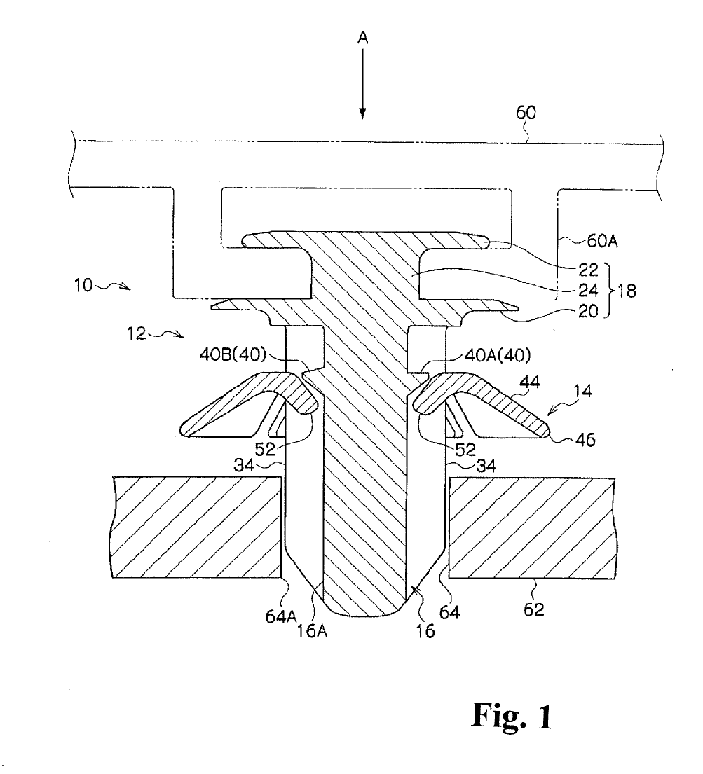

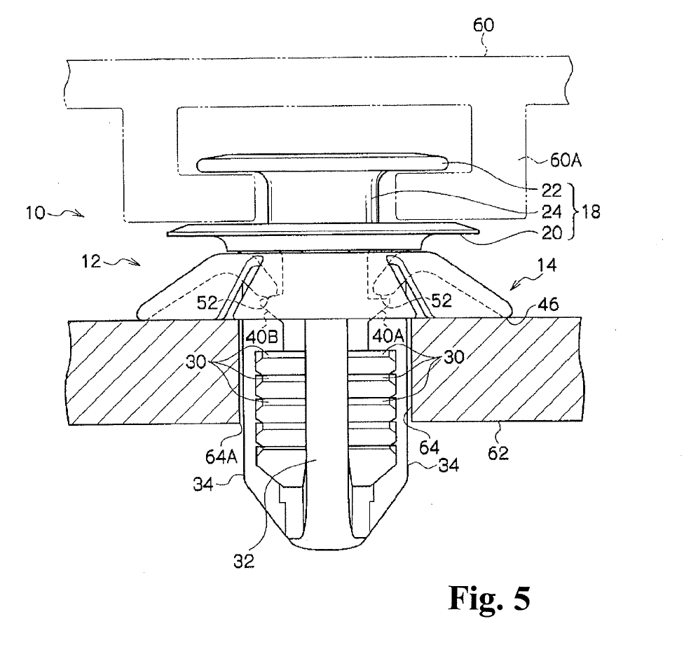

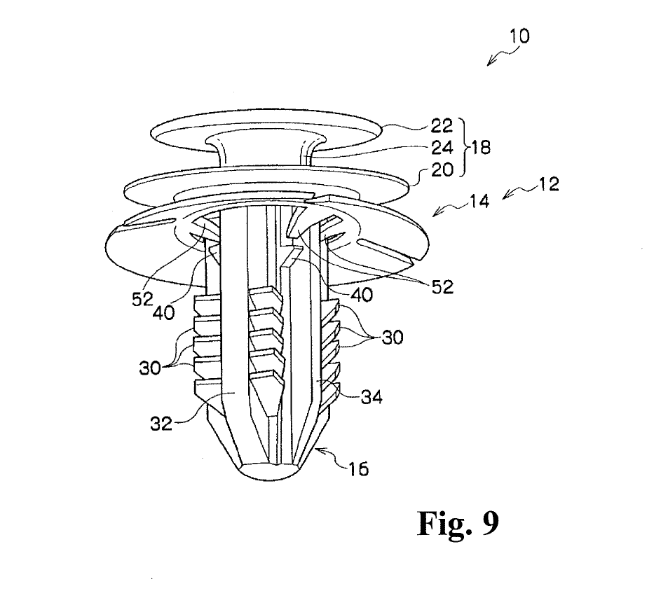

An example of a fastener according to a first embodiment of the present invention will be described according to FIGS. 1 to 9.

(General Structure)

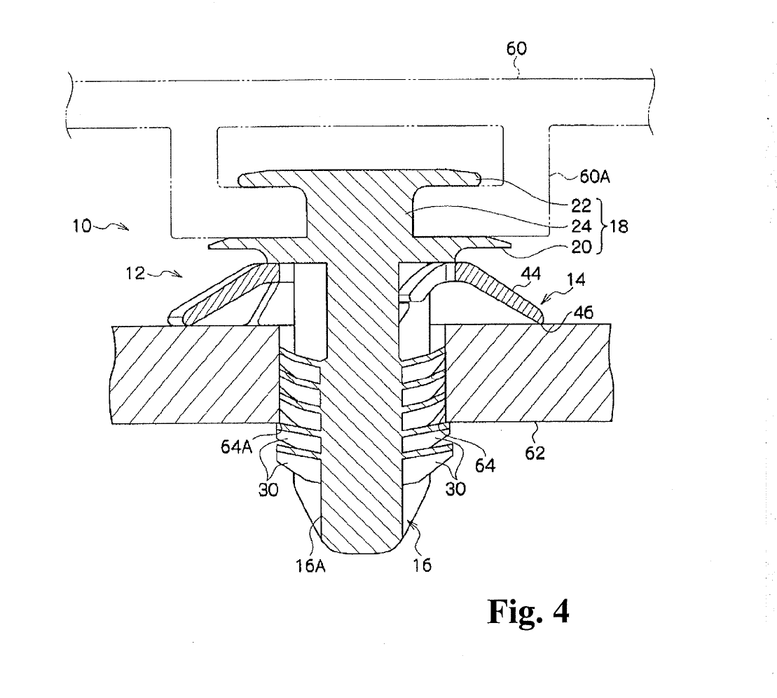

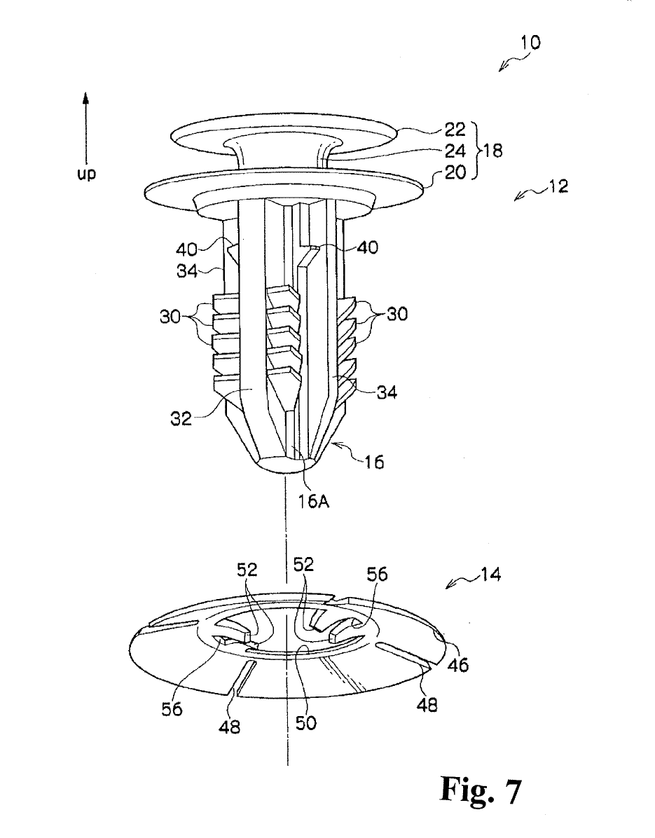

As shown in FIG. 7, the fastener 10 according to the present embodiment includes a main body member 12 to be mounted to a door inner panel 62 (see FIG. 4) as a mounted member and a flange member 14 to be mounted to the main body member 12.

The main body member 12 includes a leg portion 16 to be inserted into a mounting hole 64 (see FIG. 4) molded in the door inner panel 62 and a fixing portion 18 which is provided at an end portion of the leg portion 16 and to which a door trim 60 (see FIG. 4) as amounting member is to be fixed.

The fixing portion 18 is provided with a disc-shaped first disc portion 20 and a second disc portion 22 smaller in diameter than the first disc portion 20, the disc portions 20 and 22 disposed at a predetermined interval. The first disc portion 20 and the second disc portion 22 are connected by a circular-columnar circular column portion 24 smaller in diameter than the second disc portion 22. With this structure, a mounting seat 60A (see FIG. 4) of the door trim 60 is pinched between the first disc portion 20 and the second disc portion 22. In this way, the door trim 60 is fixed to the fixing portion 18.

On the other hand, on a peripheral face 16A of the leg portion 16 extending from the first disc portion 20, a plurality of locking claws 30 to be locked to a hole edge portion 64A (see FIG. 4) of the mounting hole 64 are provided. The locking claws 30 are elastically deformable and extending outward in a radial direction of the leg portion 16.

The plurality of locking claws 30 are provided at predetermined intervals along a longitudinal direction (inserted direction into the mounting hole 64) of the leg portion 16. The locking claws 30 are inclined so that their base ends (on a leg portion side) are closer to a tip end portion (a lower side in FIG. 7) of the leg portion 16.

With this structure, when the leg portion 16 is inserted into the mounting hole 64, the locking claws 30 are elastically deformed and bent. Then, the locking claws 30 which have passed through the mounting hole 64 elastically bounce back and the locking claws 30 which have elastically bounced back are locked to the hole edge portion 64A of the mounting hole 64 (see FIG. 4). In this way, the leg portion 16 is fixed to the door inner panel 62.

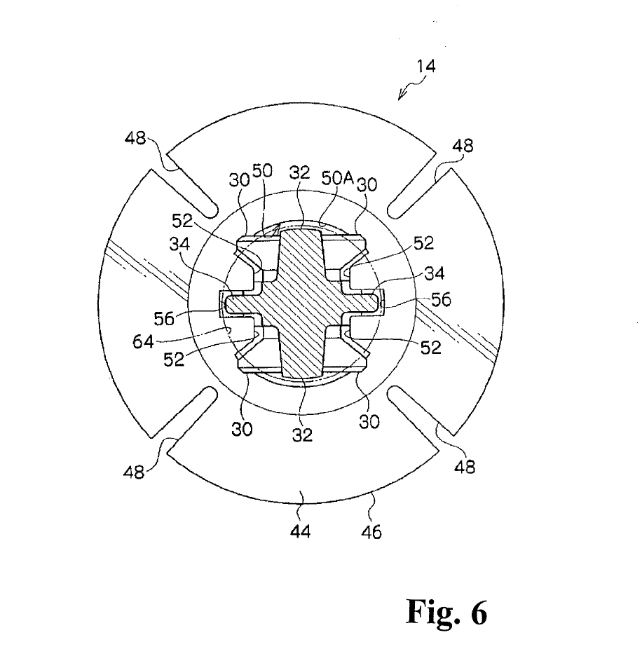

Furthermore, as shown in FIG. 6, the locking claws 30 are formed to stretch in four directions in a plan view. The locking claws 30 are provided symmetrically with respect to a pair of guide portions 34 extending in the longitudinal direction of the leg portion 16 from the peripheral face 16A of the leg portion 16 to guide the flange member 14. The flange member 14 and the guide portions 34 will be described later.

Between the locking claws 30 on one or the other side of the guide portions 34 with respect to which the locking claws 30 are provided symmetrically, a reinforcing portion 32 extending in the inserted direction and having a rectangular section is formed to protrude from the peripheral face 16A of the leg portion 16. One ends of the locking claws 30 are connected to the reinforcing portion 32. By connecting the one ends of the locking claws 30 to the reinforcing portion 32, rigidity of the locking claws 30 is secured. This maintains a fixing force of the leg portion 16 to be fixed to the door inner panel 62 at a predetermined level.

A tip end of the reinforcing portion 32 has an arc-shaped section. In this way, when the leg portion 16 is inserted into the mounting hole 64, the tip ends of the arc-shaped reinforcing portions 32 contact the inner peripheral face of the mounting hole 64 and the leg portion 16 is inserted into a predetermined position of the mounting hole 64.

(Structure of Essential Portion)

As shown in FIG. 7, between the first disc portion 20 and the locking claws 30 and on the peripheral face 16A of the leg portion 16, protruding portions 40 which are in protruding shapes are provided to sandwich the above-described guide portions 34.

As shown in FIG. 1, the protruding portions 40 sandwiching the guide portions 34 and protruding from the leg portion 16 include protruding portions 40A and protruding portions 40B. Upper faces of the protruding portions 40A facing the first disc portion 20 extend in directions orthogonal to the longitudinal direction of the leg portion 16 and upper faces of the protruding portions 40B facing the first disc portion 20 are gently inclined toward tip end portions of the protruding portions 40B.

Shapes of the protruding portions 40 are determined so that the protruding portions 40 do not contact the door inner panel 62 when the leg portion 16 is inserted into the mounting hole 64 in the door inner panel 62.

On the other hand, a surface 44 of the flange member 14 is inclined so that an outer peripheral edge 46 of the flange member 14 is farther from the first disc portion 20. Moreover, as shown in FIGS. 6 and 7, four slits 48 are formed from the outer peripheral edge 46 toward a center of the flange member 14 so as to split the surface 44 of the flange member 14.

As shown in FIG. 6, an insertion hole 50 through which the leg portion 16 is to be inserted is formed at the center of the flange member 14. Furthermore, plate chips 52 which surmount the protruding portions 40 (see FIG. 1) when the leg portion 16 is inserted into the mounting hole 64 and the flange member 14 is pressed against the door inner panel 62 are formed at a hole edge 50A of the insertion hole 50 to extend toward the center.

Moreover, an inside diameter of the insertion hole 50 is determined so that, when the leg portion 16 is inserted into the insertion hole 50, the locking claws 30 contact the hole edge 50A of the insertion hole 50 and that the leg portion 16 is inserted into the insertion hole 50 while elastically deforming the locking claws 30. In other words, if the leg portion 16 is inserted into the insertion hole 50 formed in the flange member 14, the locking claws 30 which have elastic recovery act as obstructions to prevent the flange member 14 from slipping off the leg portion 16.

Pairs of plate chips 52 are formed to face each other. Between the plate chips 52 of each pair, a recessed portion 56 guided by the above-described guide portion 34 when the leg portion 16 is inserted through the insertion hole 50 in the flange member 14 is formed.

(Operation and Effects)

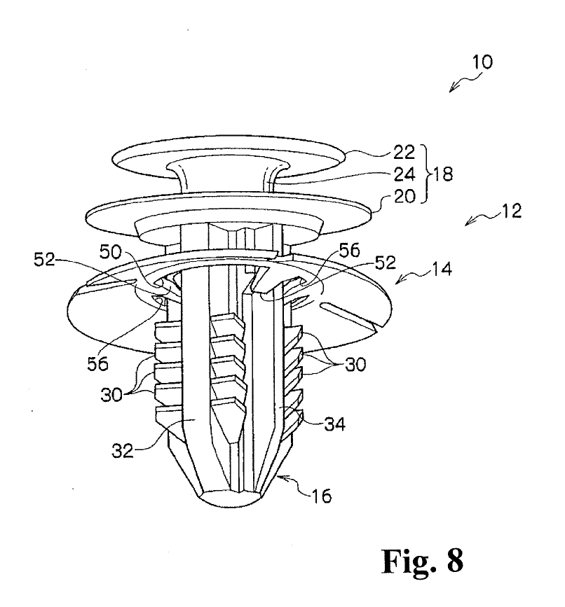

As shown in FIG. 8, to insert the leg portion 16 of the main body member 12 through the insertion hole 50 of the flange member 14, the recessed portions 56 of the flange member 14 are guided by the guide portions 34 protruding from the leg portion 16. Then, the leg portion 16 is inserted into the insertion hole 50 in the flange member 14. The flange member 14 is temporarily retained in such a position that the plate chips 52 formed at the insertion hole 50 in the flange member 14 do not surmount the protruding portions 40.

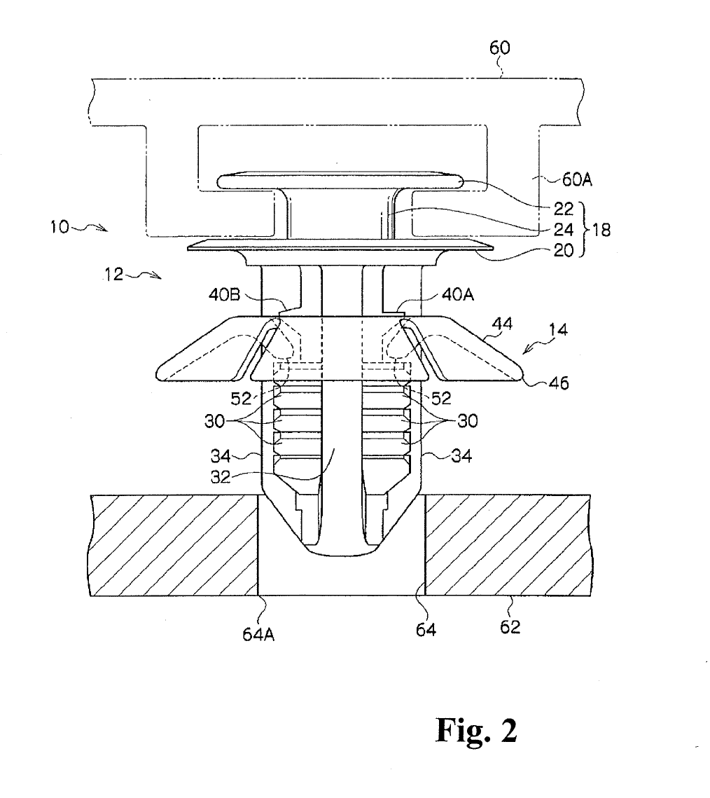

As shown in FIG. 2, the fixing portion 18 of the fastener 10 with the temporarily-retained flange member 14 is mounted to the mounting seat 60A of the door trim 60. As a result, the fastener 10 is fixed to a back face of the door trim 60.

As shown in FIG. 1, the tip end of the leg portion 16 of the fastener 10 is stuck into the mounting hole 64 in the door inner panel 62 and the door trim 60 is pressed in a direction of an arrow A shown in FIG. 1.

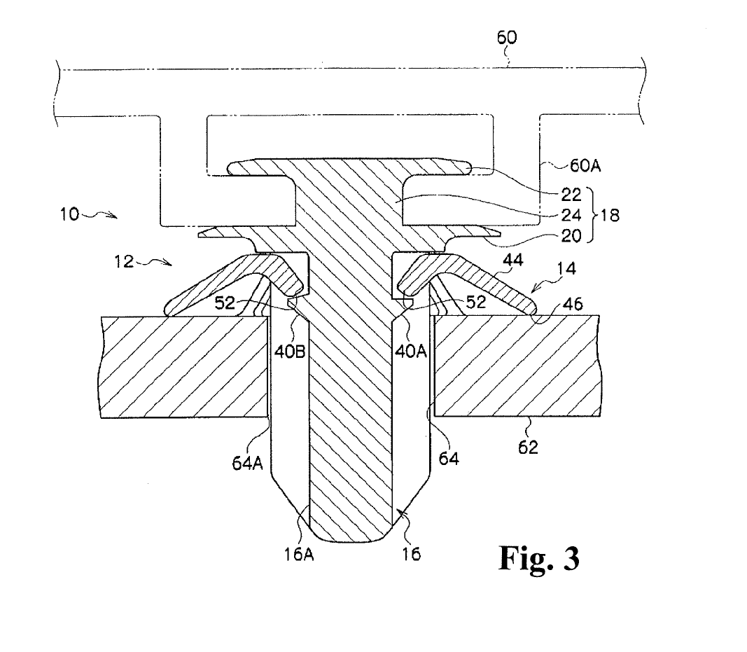

As shown in FIGS. 3, 4, 5, and 9, if the door trim 60 is pressed toward the door inner panel 62, the leg portion 16 is inserted through the mounting hole 64 and the locking claws 30 formed on the peripheral face 16A of the leg portion 16 are elastically deformed and bent. Then, the locking claws 30 which have passed through the mounting hole 64 elastically bounce back and the locking claws 30 which have elastically recovered are locked to the hole edge portion 64A of the mounting hole 64 (see FIG. 4). As a result, the leg portion 16 is fixed to the door inner panel 62. In other words, the door trim 60 is mounted to the door inner panel 62.

On the other hand, if the door trim 60 is pressed toward the door inner panel 62, the outer peripheral edge 46 of the flange member 14 contacts the door inner panel 62. Then, the flange member 14 is pressed by the first disc portion 20 toward the door inner panel 62.

If the flange member 14 is pressed by the first disc portion 20 toward the door inner panel 62, the plate chips 52 formed on the flange member 14 contact the protruding portions 40 formed on the leg portion 16 and are elastically deformed and bent. Then, when the plate chips 52 surmount the protruding portions 40, the plate chips 52 elastically recover (see FIGS. 1 and 3).

In this manner, when the door trim 60 is mounted to the door inner panel 62, the plate chips 52 surmount the protruding portions 40 and elastically recover, which gives a click feeling (tactile feedback) to an operator.

If the operator gets the click feeling, it prevents occurrence of incorrect mounting.

The shapes of the protruding portions 40 are determined so that the protruding portions 40 do not contact the door inner panel 62 when the leg portion 16 is inserted into the mounting hole 64 in the door inner panel 62. Therefore, even if the shapes of the protruding portions 40 are changed to tune the click feeling, it does not change a force of the leg portion 16 to be inserted into the mounting hole 64.

Because the upper faces of the protruding portions 40B facing the first disc portion 20 are gently inclined toward the tip end portions, the inclinations exert effects of guiding the plate chips 52 when the plate chips 52 surmount the protruding portions 40B and the flange member 14 can surmount the protruding portions 40B without wobbling.

The recessed portions 56 formed on the flange member 14 are guided by the guide portions 34 formed to protrude from the peripheral face 16A of the leg portion 16. This prevents the flange member 14 from rotating with respect to the leg portion 16 and makes it easy to dispose the flange member 14 in a predetermined position.

By connecting the one ends of the locking claws 30 to the reinforcing portions 32, rigidity of the locking claws 30 is secured. This maintains a fixing force of the leg portion 16 to be fixed to the door inner panel 62 at a predetermined level.

The tip ends of the reinforcing portions 32 have arc-shaped sections. In this way, when the leg portion 16 is inserted into the mounting hole 64, the tip ends of the arc-shaped reinforcing portions 32 contact the inner peripheral face of the mounting hole 64 and the leg portion 16 is inserted into a predetermined position of the mounting hole 64.

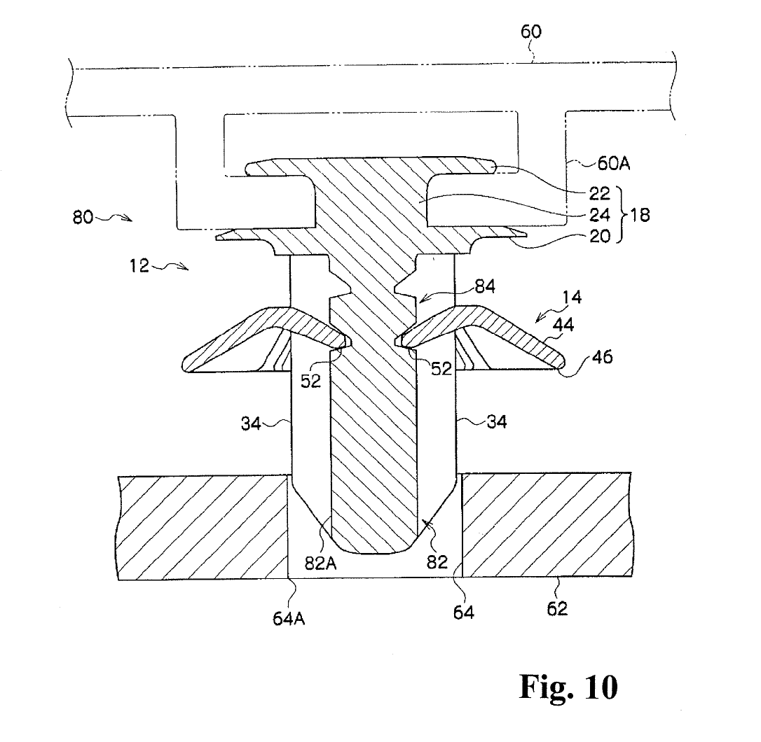

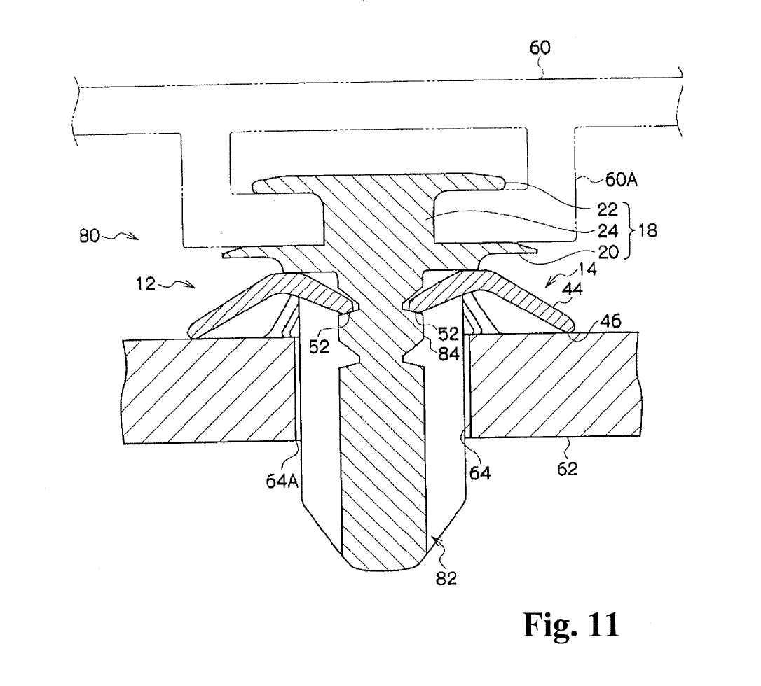

Next, an example of a fastener according to a second embodiment of the invention will be described according to FIGS. 10 and 11. The same members as those in the first embodiment will be provided with the same reference numerals and will not be described.

As shown in FIG. 10, the fastener 80 in the second embodiment is not provided with the protruding portions formed to protrude from a peripheral face 82A of a leg portion 82. However, two annular recessed portions are formed in the peripheral face 82A of the fastener 80. In this way, a tactile feedback portion 84 which the plate chips 52 surmount is formed.

With this structure, as shown in FIG. 10, a tip end of the leg portion 82 of the fastener 80 is stuck into the mounting hole 64 in the door inner panel 62. Then, the door trim 60 is pressed toward the door inner panel 62 from outside the door trim 60.

As shown in FIG. 11, if the door trim 60 is pressed toward the door inner panel 62, the outer peripheral edge 46 of the flange member 14 contacts the door inner panel 62. Then, the flange member 14 is pressed by the first disc portion 20 toward the door inner panel 62.

If the flange member 14 is pressed by the first disc portion 20 toward the door inner panel 62, the plate chips 52 formed on the flange member 14 contact the tactile feedback portion 84 formed on the leg portion 82 and are elastically deformed and bent. Then, when the plate chips 52 surmount the tactile feedback portion 84, the plate chips 52 elastically recover.

In this manner, when the door trim 60 is mounted to the door inner panel 62, the plate chips 52 surmount the tactile feedback portion 84 and elastically recovers, which gives a click feeling (tactile feedback) to an operator.

### EXPLANATION OF REFERENCE NUMERALS

10 fastener
12 main body member
14 flange member
16 leg portion
16A peripheral face
18 fixing portion
30 locking claw
34 guide portion
40 protruding portion (tactile feedback portion)
40A protruding portion (tactile feedback portion)
40B protruding portion (tactile feedback portion)
50 insertion hole
50A hole edge
52 plate chip (surmount portion)
56 recessed portion
60 door trim (mounting member)
62 door inner panel (mounted member)
64 mounting hole
64A hole edge portion
80 fastener
82 leg portion
82A peripheral face
84 tactile feedback portion

1. A fastener comprising:
a main body member including a leg portion adapted to be inserted into a mounting hole formed in a mounted member, a plurality of locking claws provided on a peripheral face of the leg portion and adapted to be locked to a hole edge portion of the mounting hole, a fixing portion provided on an end portion of the leg portion and adapted to be fixed to a mounting member mounted to the mounted member, and a tactile feedback portion provided on the peripheral face of the leg portion;
a flange member inserted into the leg portion provided on the main body member, the flange member being pressed against the mounted member when the leg portion is inserted into the mounting hole formed in the mounted member and the mounting member is mounted to the mounted member; and
a surmount portion formed on the flange member, the surmount portion surmounting the tactile feedback portion when the flange member is pressed against the mounted member.

2. A fastener according to claim 1, wherein the tactile feedback portion is provided at a position which does not contact the mounted member when the leg portion is inserted into the mounting hole in the mounted member.

3. A fastener according to claim 1, wherein the tactile feedback portion comprises protruding portions protruding from the peripheral face of the leg portion; and
the surmount portion comprises plate chips extending from a hole edge of an insertion hole toward a center of the flange member and surmounting the protruding portion.

4. A fastener according to claim 3, wherein a guide portion for guiding the flange member in which the leg portion is inserted is formed to extend in a longitudinal direction of the leg portion and to protrude from the peripheral face of the leg portion; and
a pair of plate chips is provided on the flange member and a recessed portion guided by the guide portion is formed between the pair of plate chips.
